(19) United States
(12) Patent Application Publication
(10) Pub. No.: US 2010/0257344 A1
(43) Pub. Date: Oct. 7, 2010

(54) Installation and Setup Instructions with Attached Media

(75) Inventors: Elizabeth Hatfield, Cary, NC (US); Kenneth A. High, Cary, NC (US); Mark E. Molander, Cary, NC (US)

Correspondence Address: LIEBERMAN & BRANDSDORFER, LLC, 802 STILL CREEK LANE, GAITHERSBURG, MD, 20878, US

(73) Assignee: INTERNATIONAL BUSINESS MACHINES CORPORATION, Armonk, NY (US)

(21) Appl. No.: 12/417,991

(22) Filed: Apr. 3, 2009

(51) Int. Cl. G06F 1/00

(52) U.S. Cl. 713/1; 717/174

(57) ABSTRACT

An apparatus and kit to facilitate installation of hardware and software elements of a physical computer system. Poster media is provided with an ordered list of hardware oriented instructions, and at least one item in the list having software oriented installation instructions. Transportable media is attached to the poster media adjacent to the software oriented instructions to provide both the required software, as well as the timing for the installation at the correct time in the system installation process.

### BACKGROUND OF THE INVENTION

1. Technical Field

This invention relates to installation and set up of a computer system employing both hardware and software installation components. More specifically, the invention relates to a physical media for combining instructions for installation and setup of both the hardware and software components in a single physical location.

2. Description of the Prior Art

Installation of a computer system commonly employs installation of one or more physical hardware elements, as well as installation of complementary software elements. Hardware generally refers to objects that can be physical touched. Examples of hardware include, but are not limited to, disks, disk drives, visual displays, keyboards, printers, boards, chips, etc. In contrast, software generally refers to computer instructions, programs, or data. More specifically, software pertains to elements that are electronically stored on digital storage media. Software is often divided into two categories, including system software and application software. System software includes the operating system and all utilities that enable the computer to function. Application software includes programs that function to perform tasks for users, including patches and updates to correct faults and/or otherwise update previously released versions of the application software. Accordingly, hardware provides the physical structure that supports the operation of system and application software and utilities.

Hardware components may be stored in a computer rack or a computer chassis. A computer rack, also known as a rack, is a frame used to hold various hardware devices, such as servers, switches, hard disk drives, modems, and other electronic equipment. The computer chassis, also known as a cabinet, is an enclosure that is employed to house computer hardware devices. In one embodiment, the cabinet is employed in a personal computer environment. In both a rack and a chassis environment, it is known that installation and setup of components may be complex as they typically require a specific sequence of multiple steps for the multiple components. Installation and setup of a system is often a difficult error-prone task and many people often fail to complete the installation without assistance.

It is known in the art to provide a step-by-step linear flow of instructions in documentation for the installation of hardware components. Examples of such instructions include, but are not limited to, a start poster and a start guide. In one embodiment, such posters and guides are referred to as a quick start poster and a quick start guide. It is known in the art that system setup typically spans both hardware and software installation components. For example, once the installer gets the physical hardware elements properly place in the rack and cabled there may be a need to install software components for the remainder of the installation process. In one embodiment, the software component installation may be at a different junction in the installation process. Regardless of when the software component installation is required, it is a part of the installation process and is commonly provided in accessory instructions on portable storage media in the form of a computer disk or other similar software storage device. Accordingly, locating and retaining the computer disk in a known location is an important aspect of the computer system installation process.

Quick start posters are commonly applied to provide step-by-step instructions in the installation process for hardware components. However, the physical poster cannot provide in-context instructions for the software installation steps. Accordingly, there is a need in the art to provide an apparatus or kit for a computer system installation that maintains the computer installation disk in a known location so as to mitigate loss and/or misplacement of the installation disk.

### SUMMARY OF THE INVENTION

This invention comprises an apparatus and kit for conveying installation of hardware and software components of a computer system, while mitigating loss of a media storing software installation instructions and ensuring installation of the software component at the correct time in the system installation process.

In one aspect of the invention, an apparatus is provided to convey instructions for a computer system setup. A single physical setup media is provided with written installation instructions to present hardware oriented instructions directed to installation of an associated hardware product. This same single physical item is also provided with written software installation instructions to present software oriented instructions directed to installation of software setup media for a software product associated with the hardware product. The single physical item combines both the hardware and software instructions onto a single medium to synchronize hardware installation of the hardware product or subsystem with software installation of the product or subsystem. In addition, a digital storage information medium is provided in communication with the physical setup media. The digital storage medium stores software required to complete installation, and provides for operation of the hardware product in the computer system. A securing element is provided to secure the digital storage medium to the single physical item.

In another aspect of the invention, a kit is provided to convey instructions to setup a computer system. The kit includes a single physical setup media with written installation instructions for setup of hardware and software elements of the computer system. The physical setup media has hardware instructions to present at least one hardware oriented instruction directed to installation of an associated hardware product, and at least one software installation instruction directed to installation of software setup media for the software element associated with the hardware product. A digital storage information medium is provided to store installation instructions for at least one of the software and/or hardware elements. The installation instructions include software required to complete installation, and provides for operation of the hardware product in the computer system. In addition, an attachment element is provided to removably secure the digital storage information medium to the single physical setup media.

Other features and advantages of this invention will become apparent from the following detailed description of the presently preferred embodiment of the invention, taken in conjunction with the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention unless otherwise explicitly indicated. Implications to the contrary are otherwise not to be made.

FIG. 1 is a block diagram of a setup poster according to the preferred embodiment of this invention, and is suggested for printing on the first page of the issued patent.

### DESCRIPTION OF THE PREFERRED EMBODIMENT

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided to support a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

### Overview

A poster for installation of one or more computer systems is configured to include instructions for both hardware and software oriented components of the installation process. The poster includes indicia in the form of hardware installation instructions with an overview of the steps of the installation process for the hardware components of the system(s), including the order in which different components are required for installation. The poster may different forms, including a single sheet of paper-based instructions, a multi-sheet set of instructions, and combinations thereof. The term poster employed herein may apply to various configurations of an instruction set for installation employed to dictate a single cohesive unit of instructions. Software installation instructions are provided on the same poster for installation of the software component(s) at the precise step in the system installation process when software installation is required for install. In addition, computer readable media with computer instructions stored thereon is physically attached to the poster at the location where the software installation instructions are provided to provide instructions and setup program necessary for installation of the software component. In one embodiment, the setup program may be in the form of a setup wizard, which makes changes in existing software and firmware without installation of additional software or firmware. By physically attaching the media to the poster at the location in the order of instructions, it is clearly indicated when the media is employed for installation of the software component(s) of the system installation, while also removing the aspect of loss of the media in the multitude of components to be installed and setup in the system. In one embodiment, the media is employed exclusively for the software installation aspect of the system install.

### Technical Details

In the following description of the embodiments, reference is made to the accompanying drawings that form a part hereof, and which shows by way of illustration the specific embodiment in which the invention may be practiced. It is to be understood that other embodiments may be utilized because structural changes may be made without departing form the scope of the present invention.

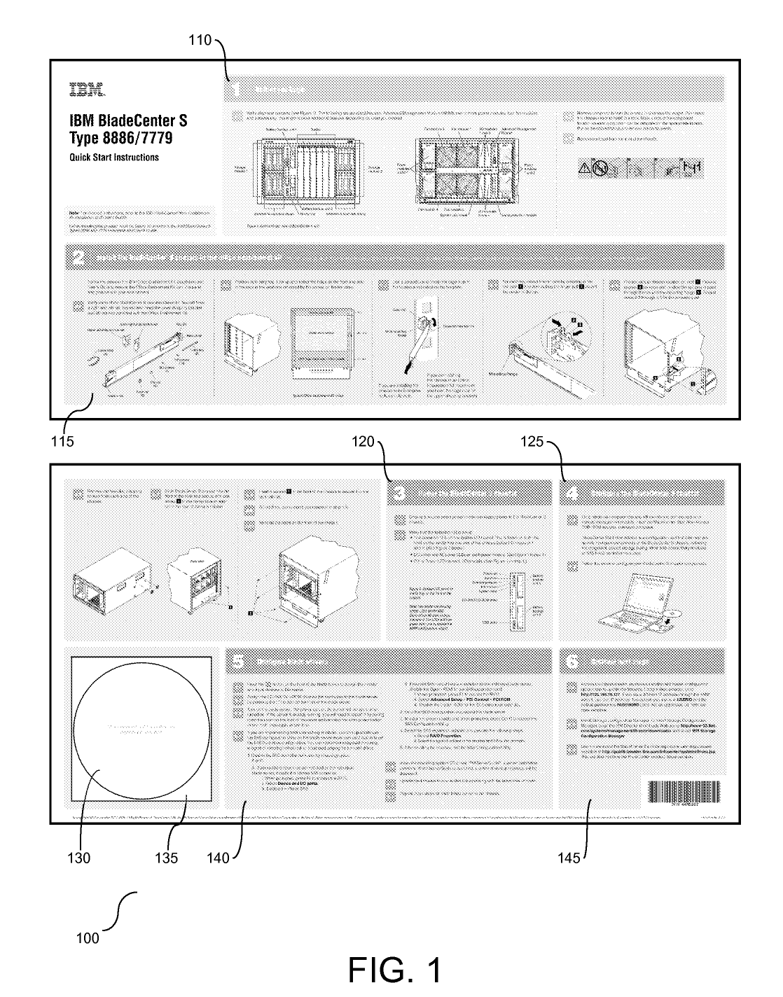

FIG. 1 is a block diagram of a setup poster (100) employed for installation and initial setup of hardware and software components of a computer system. As shown, the poster is divided into six frames, with each frame pertaining to a different aspect and step of the overall installation process. The first frame (110) addresses aspects for the installer of the system before the installation process begins. The first frame is directed to identifying different hardware components of the system. The second frame (115) addresses the first aspect of the hardware installation process. In this example, the second frame (115) starts the hardware installation process for the system. The third frame (120) directs the installer to deliver power to the system being installed. The fourth frame (125) directs the installer to software configuration for the system, and directs the installer to computer readable media in the form of a CD-ROM (130) that is secured to the fifth frame (135) of the poster. Although the computer readable media is shown herein the form of a CD-ROM, the invention should not be limited to this format for providing software components or conveying instructions for the software installation of the system. In one embodiment, the computer readable media may be in the form of a DVD, a flash drive, a memory stick, a thumb drive, or another form of transportable media. In one embodiment the DVD would automatically start a setup wizard to initially setup the software part of the installation. Once this step is completed, the poster directs the installer to the remaining hardware components of the installation process as well as other parts of the software setup as demonstrated at the sixth and seventh frames (140) and (145). It should be noted that the hardware installation instructions on the demonstrated setup poster (100) are merely illustrative. In one embodiment, the hardware installation instructions may be modified to a different set and/order of instructions. Accordingly, the computer readable media is physically attached to the poster to enable the installer to view the hardware installation instructions while facilitating location of the software installation instructions and components.

The transportable media for supporting the software installation and components may be secured to the poster with a variety of attachment elements. In one embodiment, the attachment element is in the form of glue dots with sufficient strength to hold the transportable media to the poster, while allowing removal of the transportable media from the poster without damaging the transportable media. A glue dot is an adhesive that bonds to a secondary material as it is applied thereto. Upon applying the glue dot to the poster, the portion of the glue dot that is attached to the poster bonds with the material of the poster. Similarly, upon placing the transportable media in contact with a different portion of the glue dot, the transportable media bonds with the different portion of the glue dot. The glue dot may vary in thickness and degree of adhesion depending upon the size and configuration of the transportable media, as well as the characteristics and properties of the poster. Accordingly, glue dots may be employed as an adhesive to secure the transportable media to the poster.

There are other forms of attachment elements that may be employed in combination with or separate from the glue dots to ensure that the transportable media remains attached to the poster until such time as the installation requires use of the transportable media. One such attachment element is a die cut in the surface of the poster. A die cut includes one or more apertures in the surface of the poster that are sized to hold the edge(s) of the transportable media. For example, for a CD-ROM or DVD, two die cuts may be formed in the poster to receive diametrically opposite sides of the CD-ROM or DVD, and thereby secure the transportable media to the poster. Another attachment element is known in the art as sticky tape, which consists of a pressure sensitive adhesive coated onto a backing material. In one embodiment, a removable liner may be employed to protect the adhesive until the liner is removed. Upon applying the adhesive to a secondary surface and applying pressure thereto, the adhesive bonds to the secondary surface. With respect to the poster and the transportable media, the tape may be applied to extend from the poster and across the width or diameter of the transportable media, to bond the transportable media to the poster. In another embodiment, the transportable media may be housed in a secondary enclosure, such as an envelope. The secondary enclosure may be formed as a separate pocket attached to the poster or from portions of the poster, with the transportable media retained within the confines of the secondary enclosure. In the embodiment where the secondary enclosure is a separate pocket, a material, such as an adhesive, is employed to secure the second enclosure to the poster. Similarly, in another embodiment where the pocket is formed from the poster itself, a perforation may be employed to facilitate removal of the transportable media from the pocket. Accordingly, there are a variety of elements that may be employed to secure or otherwise attach the transportable media to the poster for installation of software components of the computer system.

As shown in FIG. 1, the transportable media is secured to the poster and employed in the installation process at an intermediate point of the installation. However, the invention should not be limited to this specific juncture of employment of the software installation and setup. When a computer system is installed and requires installation of both hardware and software components, the software installation may take place at different stages of the installation process. For example, in one embodiment, the software installation is at the conclusion of the hardware installation process. In another embodiment, there may be multiple instances in which software installation may take place in the system installation process wherein the software installation is inter-mixed with hardware installation instructions. For instance, the first CD might automatically start a wizard that sets up the underlying system software and firmware, and a second CD might run a wizard that installs and sets up operating systems on the servers in the overall computer system. The poster may be configured with frames to indicate which steps require hardware installation instructions, and which steps require software installation components, with transportable media secured to the poster at the location(s) which indicate software installation.

Furthermore, as shown in FIG. 1, the poster is created with multiple frames, with at least one frame indicating hardware installation and at least one frame having transportable media for software installation and/or setup. In one embodiment, the transportable media and the frame setup media may be elements of a kit that are configured to be assembled for transport with the hardware elements of the computer system. More specifically, the poster media is provided with multiple frames, with at least one frame having software installation instructions. Transportable media in the form of a digital storage information medium is provided separate from the poster media. The transportable media stores installation instructions, including programs such as wizards and setup aids, for at least one of the software and/or hardware elements. Prior to transport of the hardware elements together with the poster media, an attachment element is employed to removably secure the transportable media to the poster media. Accordingly, the poster elements may be elements of an installation kit that are assembled prior to delivery of the hardware installation components.

### Advantages Over the Prior Art

Software setup media is attached to the setup poster for the installation of the computer system in the location and step in the poster at the appropriate time for installation or running of the software components of the system. Setup media is commonly employed as an instruction template for installation of hardware elements of a computer system. Sometimes the software component of the setup media will initiate a software install, such as an operating system or an application. In another embodiment, the software component will run a wizard that will setup and possibly update currently embedded software and firmware in the overall system. By attaching the transportable media to the setup poster, loss of the transportable media is mitigated, and finding it at the right point in the installation is enhanced. In addition, by securing the media to the poster, the opportunity to employ the wrong media for software installation and setup is reduced, as the correct media for installation is attached directly to the poster. The media secured to the poster provides both the software installation component and the timing of the installation and setup, which mitigates the chance of an improper installation by installing or setting up the software component out of order of the system installation. Accordingly, one or more posters are provided with a combination of hardware and software installation instructions, and with transportable media attached to the poster(s) adjacent to the software installation instruction(s).

### Alternative Embodiments

It will be appreciated that, although specific embodiments of the invention have been described herein for purposes of illustration, various modifications may be made without departing from the spirit and scope of the invention. In particular, secondary indicia may be applied to or integrated with the transportable media or attachment element employed to attach the transportable media to the poster. The secondary indicia may be in the form of adding branding value to the underlying system, or may be in the form of a warning message, such as a prerequisite aspect that must be done before employing the transportable media. Furthermore, the invention has been described as a poster media for setup instructions for a computer system. However, the invention should not be limited to information for setup and installation of a computer system. In one embodiment, the poster media may have indicia for setup instructions for a combination of hardware and software elements that do not pertain to installation of a computer system, such as a printer. Similarly, the poster media may come in different forms, including cardstock, paper, lamination, fan-fold quick start guides, multi-page booklets, etc. Accordingly, the scope of protection of this invention is limited only by the following claims and their equivalents.

We claim:

1. An apparatus to providing instructions for a computer system setup comprising:
a single physical setup media having a written installation instruction to present hardware installation instructions directed to installation of an associated hardware product;
the single physical item having a written installation instruction to present software installation and setup instructions directed to software setup media for a software product associated with the hardware product, wherein the software setup is selected from the group consisting of: installation of additional software, installation of a setup wizard, and running of software;
the single physical item to combine the hardware and software instructions onto a single medium to synchronize hardware installation of the hardware product with software installation of the product;
a digital storage information medium in communication with the physical media, the digital storage medium to store software installation instructions to complete installation and to provide for operation of the hardware product in the system; and
a securing element to secure a digital storage medium to the single physical item.

2. The apparatus of claim 1, wherein the hardware installation instruction provides an order of installation for elements of the hardware product and the software product.

3. The apparatus of claim 2, further comprising said software installation instructions placed at a conclusion of the hardware oriented instructions.

4. The apparatus of claim 2, further comprising said software installation instructions placed at an intermediate area within the hardware oriented instructions.

5. The apparatus of claim 1, wherein said digital storage medium is attached to said setup media by a means selected from the group consisting of: glue dots, cuts in the poster, sticky tape, attached pocket with a flap, attachment to a perforated tear-off area, and combinations thereof.

6. The apparatus of claim 1, wherein said digital storage medium is selected from the group consisting of: CD, DVD, thumb drive, and memory stick.

7. The apparatus of claim 1, wherein the single physical item is in a form selected from the group consisting of: a poster, a pamphlet, a booklet, and a book.

8. A kit to provide instructions to setup a computer system, the kit comprising:
a single physical setup media to include instruction for setup of hardware and software elements of the computer system, the physical setup media having hardware installation instructions to present hardware oriented instructions directed to installation of an associated hardware product and software installation instructions directed to installation to software setup media for a software product associated with the hardware product, wherein the software setup is selected from the group consisting of: installation of additional software, installation of a setup wizard, and running of software;
a digital storage medium to store installation instructions for at least one of the software and hardware elements; and
an attachment element to removably secure the digital storage medium to the single physical setup media.

9. The kit of claim 8, wherein the hardware installation instructions provide an order of installation for both the hardware and software elements of the product.

10. The kit of claim 9, further comprising said software installation instructions placed at a conclusion of the hardware installation instructions.

11. The kit of claim 9, further comprising said software installation instructions placed at an intermediate area within the hardware installation instructions.

12. The kit of claim 8, wherein said digital storage medium is attached to said setup media by a means selected from the group consisting of: glue dot, cuts in the poster, sticky tape, attached pocket with a flap, attachment to a perforated tear-off area, and combinations thereof.

13. The kit of claim 8, wherein said digital storage medium is selected from the group consisting of: CD, DVD, a thumb drive, and memory stick.

14. The kit of claim 8, wherein the single physical item is in a form selected from the group consisting of: a poster, a pamphlet, a booklet, and a book.
